(19) United States
(12) Patent Application Publication
(10) Pub. No.: US 2013/0196845 A1
(43) Pub. Date: Aug. 1, 2013

(54) COLLOIDAL PHOTO-CATALYTIC COMPOSITION

(71) Applicants: Jaromir Jirkovsky, Praha (CZ); Frantisek Peterka, Praha (CZ); Jan Subrt, Praha (CZ); Marc Lambrecht, Brussels (BE)

(72) Inventors: Jaromir Jirkovsky, Praha (CZ); Frantisek Peterka, Praha (CZ); Jan Subrt, Praha (CZ); Marc Lambrecht, Brussels (BE)

(73) Assignee: EOXOLIT SPRL, Brussels (BE)

(21) Appl. No.: 13/703,265

(22) PCT Filed: Jun. 14, 2011
(86) PCT No.: PCT/EP2011/059869

§ 371 Date: Apr. 10, 2013

(30) Foreign Application Priority Data
Jun. 11, 2010 (CZ) PV 2010-465

(51) Int. Cl. B01J 31/38

(52) U.S. Cl. CPC B01J 31/38
USPC 502/1; 502/232; 502/242; 502/159

(57) ABSTRACT

A photo-catalytic composition, comprising nanoparticles of at least one photo-catalyst and an aqueous colloidal dispersion of SiO₂ nanoparticles wherein the concentration of the photo-catalyst ranges from at least 20 to less than 50 parts by weight and the concentration of SiO₂ provides the balance to 100 parts by weight.

This invention relates to a photo-catalytic composition, comprising nanoparticles of at least one photo-catalyst and an aqueous colloidal dispersion of SiO₂ nanoparticles according to the preamble of the first claim. The present invention also relates to a process for manufacturing such a photo-catalytic composition as well as to its use as an additive in paints and cement and as a treating agent for stones, roofing and textile.

Photo-catalytic compositions which comprise nano particles of photo-catalytic materials such as titanium oxide are well known in the art. Upon irradiation with UV or visible light the material exhibits photo-catalytic activity, as a result of which non-selective oxidative destruction of a wide range of organic compounds and biological species absorbed on the surface of the particles may be achieved. In particular irradiation with UV, causes formation of oxygen-containing radicals (O. and OH.) on the surface of the photo-catalytic particle, which are reactive with organic compounds to convert them into CO₂. Examples of organic species that may be decomposed by photocatalysis include bacteria, viruses and fungi and all kinds of proteins or toxic components (self cleaning effect). Due to their unique physical and chemical properties, photo-catalytic compositions may be used in a wide range of applications. In practical applications, compositions of nanoparticles of photo-catalytic materials may be deployed on surfaces of various substrates such as glass, ceramics or metals as a coating or as an additive to paint or varnish to provide layers that exhibit self sterilization and self cleaning properties when they are exposed to the light.

There are general difficulties connected with the photocatalytic applications represented by an insufficient long-term adhesion of the photocatalyst coatings on some kinds of supports (e.g. plastics) and an undesirable photocatalytic degradation of organic components of painting systems leading to their gradual destruction (e.g., chalking of paints). Photocatalytic degradation is namely a non-selective process that degrades undesirable organic compounds as well as organic molecules of supports or binders. The aim of the submitted patent is to reduce markedly these negative effects.

EP1069950 by Ahlstrom describes photo-catalytic compositions comprising nanoparticles of a photo-catalytic material and an aqueous colloidal dispersion of silicon dioxide nanoparticles with a diameter of 10 to 40 nm in which the silicon dioxide particles represent from 20 to 50 wt. % of the dispersion. Homogeneous dispersions are obtained, wherein the silica particles are capable of bonding together after having coated the particles of the photo-catalytic material. The stability of the dispersions disclosed in EP1069950 however seems to strongly depend on the production process. Unstable dispersions may result in a precipitation of the nanoparticles in the dispersion and negatively affect their photo-catalytic activity and their potential use.

There is thus a need for a composition, in particular a dispersion of nanoparticles of photo-catalytic materials with improved stability.

It is therefore the object of this invention to provide a photo-catalytic composition, in particular a dispersion, with an improved stability.

This is achieved according to the present invention with a photo-catalytic composition showing the technical features of the characterizing portion of the first claim.

Thereto, the photo-catalytic composition of this invention is characterised in that the concentration of the photo-catalyst ranges from at least 20 to less than 50 parts by weight and the concentration of SiO₂ provides the balance to 100 parts by weight. The amounts of photo-catalyst and SiO₂ are given as dry matter, in the photo-catalytic composition.

Within the framework of this invention, nanoparticles of a photo-catalyst are understood to comprise photo-catalyst particles having an average particle size between 5-3000 nm, preferably between 10-500 nm. An aqueous colloidal dispersion of SiO₂ nanoparticles is understood to comprise SiO₂ particles having an average particle size of less than 100 nm. The aqueous SiO₂ dispersion will usually act as the binder for the photo-catalyst particles. The photocatalytic composition of this invention will usually take the form of an aqueous dispersion. “Photocatalytic composition” is understood to comprise a catalytic composition capable of decomposing organic compounds adsorbed on the photo catalyst particles or in contact therewith, by a photochemical reaction caused by UV-irradiation. This chemical reaction is known as “photo-catalysis”. The UV radiation will usually have a wavelength less than 380 nm.

The inventors have found that the presence of an excess SiO₂ nanoparticles with respect to photo-catalyst nanoparticles in the colloidal dispersion of the photo-catalytic composition of the present invention, results in a dispersion in which the photo-catalyst nanoparticles aggregate to form larger discrete aggregates. The SiO₂ nanoparticles adhere to and are dispersed between these aggregates of the photo-catalyst. The SiO₂ nano particles at least partly surround the photo-catalyst particles to form a protective shield. Thereby the photo-catalyst particles may be substantially completely surrounded by the SiO₂ particles of the SiO₂ dispersion or only partially to a desired extent. It has been observed that the presence of aggregates of photo-catalyst nanoparticles surrounded by SiO₂ nanoparticles increases the efficiency of the photo-catalytic composition. The ability of small organic as well as inorganic molecules to penetrate through the shielding formed by the SiO₂ particles towards the TiO₂ phase may explain the observed increase of efficiency of photocatalytic reaction, possibly due to prolonged contact of degraded molecules with the photocatalyst. Besides that, hydroxyl radicals generated as primary radicals by the photocatalyst upon UV-irradiation, are capable of leaving the photocatalyst surface and of penetrating through the SiO₂ structure which surrounds the photo-catalyst particles into the surrounding medium, where they are available for reaction with organic and/or inorganic substances present in the composition or formulation comprising the photocatalytic composition of this invention. The reactions of OH radicals with organic molecules lead to corresponding organic radicals which, because of their unpaired electrons, are extremely reactive. Molecular oxygen may form the corresponding peroxyl radicals. These radicals usually terminate through recombination or disproportionation giving relatively stable partly oxidized organic compounds. Consecutive OH attacks may cause gradual creation of an increasing amount of oxidized organic molecules up to mineralization, i.e., complete transformation of all organic structures into inorganic products (e.g. carbon dioxide, water and corresponding mineral acids).

The larger the concentration of SiO₂ nanoparticles, the larger the part of the surface of the photo-catalyst particles/aggregates that may be covered. Depending on the relative concentration of the photo-catalyst and SiO₂ nanoparticles, multi-layer coverage may be achieved. As SiO₂ nanoparticles are transparent to UV and visible light, they do not adversely affect the catalytic activity.

A preferred embodiment of the photo-catalytic composition according to the invention is characterized in that in that the SiO₂ nanoparticles are ionic. Thereby the SiO₂ nanoparticles may either be anionic or cationic. Anionic SiO₂ nanoparticles will mostly be used with positively charged photocatalytic particles, cationic SiO₂ nanoparticles will mostly be used with negatively charged photocatalytic particles. The inventors have found that it is important to distinguish anionic and cationic SiO₂.nanoparticles, given that fact that they show different stability regimes in their interaction with the photo-catalyst nanoparticles, related to their different acid-base properties, when present in the photo-catalytic composition according to the invention.

The electric charge of the SiO₂ and TiO₂ particles may be altered by addition of a pH buffer, to provide optimum adhesion of the SiO₂ and TiO₂ particles and optimise the stability of the dispersion. The buffer may be acidic or alkaline, depending on the envisaged charge. The buffer may either comprise an acid and the salt of its conjugated base, or a base and the salt of its conjugated acid. The amount of buffer added may vary within wide ranges, depending on the amount needed to achieve sufficient stability of the dispersion.

A preferred embodiment of the photo-catalytic composition according to the invention is characterized in that in that the SiO₂ nanoparticles in the aqueous colloidal dispersion have a particle size between 5 and 50 nm, preferably between 5 and 40 nm, more preferably between 9 and 30 nm. Commercially available aqueous dispersions often contain SiO₂ nano particles with narrow average particle size distributions, for example an average particle size of respectively 9, 15 or 30 nm. However, SiO₂ dispersions with other average particle sizes are commercially available as well. If so desired, either one single of the afore-mentioned aqueous dispersions may be used, or a mixture of two or more of these dispersion in appropriate ratios. The inventors have found that SiO₂ nanoparticles with a particle size in the afore-mentioned ranges may be well dispersed in the presence of the photo-catalyst particles and permit to achieve optimal surrounding of the photo-catalyst particles which promotes the stability of the dispersion of the photo-catalyst and the SiO₂ particles.

A further preferred embodiment of the photo-catalytic composition according to the invention is characterized in that the particles of the photo-catalyst have an average particle size between 5 and 3000 nm, preferably between 7-2500 nm, more preferably 10-1500 nm, most preferably between 10 and 500 nm. The inventors have found that controlling of the particle size of the photo-catalytic nanoparticles contributes to improving the photo-catalytic activity of the photo-catalytic composition.

A still further preferred embodiment of the photo-catalytic composition according to the invention is characterized in that the photo-catalyst is a TiO₂ more preferably anatase TiO₂. Anatase TiO₂ nanoparticles have been found to be the most promising material for photo-catalytic compositions, because it is an environmentally friendly material, which is expensive and shows good photocatalystic activity. In practice, upon activation by UV-light, anatase is electronically modified so as to lead to the formation of hydroxyl radicals OH. and oxygen radicals O. capable of reacting with organic compounds until they are converted into carbon dioxide. The anatase TiO₂ may be used as such or it may be doped with cations, anions of various elements of the periodic system in order to shift the absorption frequency. Examples of suitable doping agents include cations of various elements for example C, N, S, Zr, V, Mo, Nb, W etc; mixed oxides such as TiO₂/SiO₂, semiconductors such as ZnO, ZnS, WO₃, ZrTi₃ and particles of TiO2 with noble metals deposited on the surface e.g. Ag, Au, Pt, etc.

The colloidal SiO₂ dispersion will usually function as a binder for the photocatalyst particles, in particular the TiO₂ particles. Suitable concentrations of SiO₂ in the photo-catalytic composition as a whole to achieve a good and stable dispersion of the SiO₂ and an effective shielding and binding of the TiO₂ particles range from 0.6-48 wt. %, preferably 0.6-12 wt. %.

The stability of the dispersion of the photo-catalytic composition may be further improved by adding at least one stabiliser to improve the stability of the aqueous dispersion and to counteract precipitation. The stabiliser will usually be chosen such that it does not significantly affect the photo-catalytic activity of the photo-catalytic composition. The stabiliser may either comprise a cationic or an anionic surfactant. The stabiliser will usually be selected in such a way that the risk to decomposition by the photo-catalyst of this invention, is minimal. Particularly preferred stabilisers include those surfactants which are non-ionic, in particular non-ionic fluoropolymers. A particularly suitable fluoropolymer is PTFE (polytetrafluoroethylene), more particularly PTFE having 6-8 carbon atoms, for its low friction coefficient and the ability of the molecule to resist severe oxidative environment created by the photo-catalytic activity of the photocatalyst at minimum risk to decomposing. The concentration of the non-ionic fluoropolymer is not critical to the invention and will usually vary between 0.1-20.0 wt. %, preferably 1.0-10.0 wt. %.

The photocatalytic composition of the present invention may further contain the usual additives, such as for example a thickening agent or a surfactant, the latter being provided to enhance the penetration ability of the composition into certain materials or to enhance spreading of the composition of this invention on a surface to be treated. Examples of suitable surfactants include acrylic based surfactants, but other surfactants may be used as well. Examples of other surfactants include anionic surfactants based on sulfates such as alkyl sulfates, on sulfonates, such as sulphonate fluorosurfactants, on phosphates such as alkyl ether phosphate or carboxylates. such as carboxylate fluorosurfactants, as for example those which are commercially available from Dupont under the name Capstone. Examples also include cationic surfactants, based on pH-dependent amines, such as octenidine dihydrochloride, or on permanently charged quaternary amonium cations such as benzalkonium chloride (BAC). The concentration of the cationic or anionic surfactant is not critical to the present invention and will usually vary between 0.001-2.0 wt. %, preferably 0.005-1.0 wt. %. These preferred concentrations ranges appear to strike the best balance between the gain in stability of the dispersion and the material cost of the stabiliser. The surfactant will usually be chosen such that the risk to decomposition in the presence of the photo-catalyst is minimal.

A preferred embodiment of the photo-catalytic composition according to the invention is characterized in that that the pH of the photo-catalytic composition is in the range of (pH_{zpc}(SiO₂)+pH_{zpc}(photo-catalyst))/2+1 and (pH_{zpc}(SiO₂)+pH_{zpc}(photo-catalyst))/2−1. The inventors have found that stability problems of the photo-catalytic composition according to the invention which could result in a precipitation or gelling of the composition can be reduced by adjusting the pH of the photo-catalytic composition in the range of (pH_{zpc}(SiO₂)+pH_{zpc}(photo-catalyst))/2+1 and (pH_{zpc}(SiO₂)+pH_{zpc}(photo-catalyst))/2−1. Within this pH region it may be achieved that the photo-catalyst nanoparticles carry an electrical charge of the same polarity and that the SiO₂ particles carry an electrical charge of the same polarity as well, the electrical charge of the SiO₂ and TiO₂ nano-particles are negatively charged. Due to the opposite charges, the TiO₂ nano-particles will be surrounded by SiO₂ particles which tend to agglomerate to form shielded TiO₂ nano-particles. However, precipitation occurs at “zero point of charge” (pH_{zpc}). Here, the inventors utilize the fact the pH_{zpc} of SiO₂ and the photo-catalyst nanoparticles are very different. An appropriate pH can be set by adding a buffer.

In the photo-catalytic composition according to the present invention, the TiO₂ nanoparticles will usually form aggregates with a mean particle size of at least 0.2 μm, preferably at least 1 μm.

The concentration of TiO₂ in the dispersion of the photo-catalytic composition of this invention may vary within wide ranges and will usually range from 0.5-40 wt. %, preferably 0.5-10 wt. % on the total weight of the composition, to keep both the photo-catalytic activity of the composition and the stability of the dispersion at a high level.

The concentration of SiO₂ in the photo-catalytic composition may vary within wide ranges. Usually however the catalytic composition will comprise 0.5-55.0 wt. %, or 0.6-48.0 wt. %, preferably 0.6-12.0 wt. % on the total weight of the composition.

The invention also relates to a process for manufacturing the photo-catalytic composition according to the invention, comprising adding nanoparticles of at least one photo-catalyst to an aqueous colloidal dispersion of SiO₂ nanoparticles with the concentration of the photo-catalyst ranging from at least 20 to less than 50 parts by weight and the concentration of SiO₂ providing the balance to 100 parts by weight. If so desired water can be added, a stabiliser for stabilising the dispersion and any other additive considered suitable by the skilled person.

The inventors have observed that by using an excess of SiO₂ over TiO₂, aggregation of the TiO₂ nano particles into bigger aggregates may be achieved. Thereby the aggregates of the TiO₂ nano particles are at least partly covered or shielded or encapsulated by SiO₂, which provides the disperse phase. Optimum aggregation of the TiO₂ nano particles and shielding by and dispersion of the SiO₂ is achieved by ensuring that mixing of the SiO2 aqueous dispersion and the TiO₂ is carried out at low energy. Preferably mixing is carried out in such a way that inclusion of oxygen during mixing is reduced to a minimum. More preferably mixing is carried out in such a way that the risk to vortex formation or cavitation is minimal. The energy used to achieve mixing may be suitably adapted by the skilled person taking into account the volume and/or weight of the mixture. Mixing will usually be achieved using stirring. In order to minimise the risk to unwanted cavitation or vortex formation, the stirring speed will be controlled within certain limits. The stirring rate used to achieve mixing may be suitably adapted by the skilled person taking into account the volume and/or weight of the mixture.

The invention also relates to a photo-catalytic resin composition, a paint composition, a coating composition, a varnish composition, a toner support, an adhesive composition, a cement or concrete additive or a construction material composition, comprising the photo-catalytic composition according to the invention, which is characterized in that the SiO₂ nanoparticles in the photo-catalytic composition are anionic. A photo-catalytic paint, coating composition, varnish, coating, toner support, cement or concrete additive comprising the photo-catalytic composition according to the invention shows a good self cleaning effect. The inventors have observed that organic pollutants deposited on a surface comprising the composition of this invention or coated with a composition comprising the composition of this invention, are decomposed. This self-cleaning effect may extend to organic materials deposited on the surface as well as to living organisms, for example micro-organisms and colonies or biofilms thereof.

The invention relates to a photo-catalytic paint or cement additive comprising the photo-catalytic composition according to the invention wherein the SiO₂ nanoparticles are anionic in order to achieve a dispersion with optimum stability. The addition of a fluorosurfactant to the photo-catalytic paint additive on the other hand has the advantage that fluorosurfactants adhere to the TiO₂/SiO₂ matrix and cause migration of the matrix to the surface of the paint layer, once the paint starts to dry. The presence of the TiO₂/SiO₂ matrix on the surface of the paint layer promotes the contact between the TiO₂ and the pollutants and as a result increases the photo-catalytic effect.

The invention also relates to a photo-catalytic treating agent for stones, roofing and textile, comprising the photo-catalytic composition according to the invention. The inventors have found that a photo-catalytic treating agent for stones, roofing and textile, comprising the photo-catalytic composition according to the invention enables the oxidative destruction of a wide range of organic compounds and biological species on their surfaces. The treated materials achieve self-cleaning properties and hygienic effects by decomposing deposited organic compounds and micro-organisms, but also molecules contained in the environment, such as odors, and some inorganic gases, such as nitrogen oxides.

The invention and the advantages thereof will become more apparent from the following illustrative examples supported by the appended figure, which shows a SEM picture of a lyophilisized photo-catalytic composition according to the present invention.

The following examples show applications ranging from coating compositions, treatment of textiles and surface treatment of solid materials with varying porosities. The fundamental component of the photo-catalytic composition comprises nanoparticles of titanium oxide and silicon dioxide and is prepared from a dispersion of SiO₂ nanoparticles stabilized with alkali to which TiO₂ nanoparticles are added in the form of powder. Gelatinization of the composite dispersion may occur after standing for long periods, but this can be avoided by adding an alkaline buffer solution that maintains the pH value above 8.2.

The above-mentioned photo-catalytic composition can also be added to various coating compositions by customizing them to eliminate odors by photocatalytic degradation of volatile organic compounds, to reduce concentration of nitrogen oxides in the atmosphere, to acquire disinfection properties, for self-cleaning effects, etc. The material can be used for both waterborne lacquers and paints and for systems based on organic solvents as well as for wax or lacquers based on higher hydrocarbons or fatty acids.

A typical example of a composite system suitable for waterborne lacquers and paints is a water dispersion containing 10 g/L of TiO₂ nanoparticles, 40 g/L of SiO₂ nanoparticles (typically with a mean particle diameter 9 nm and a BET surface area having 300 m²/g) and 0.4-0.5 g/L of a no-ionic polyfluorinated surface active additive. The introduction of this additive improves the stability of the composite dispersion against separation as well as the compatibility of the composite formations with organic binders in the coating systems. As a result, the photocatalytic degradation of the organic components with of the coating surface chalked is highly suppressed. So as to improve the antibacterial effects of the coating, 5-20 g of rutile (i.e., a non-photocatalytic form of TiO₂) with regions of metallic Ag or insoluble Ag salt deposited on its surface can be added into the system. Typically, 1-5% by weight of the composite dispersion is mixed into the coating composition and by adding 3% of the composite dispersion, the maximum photocatalytic activity of the coating surface tested by the ISO 22197-1 or JIS TR Z0018 standard is generally reached.

The treatment of textiles usually involves more concentrated composite systems containing typically 100 g/L of TiO₂ nanoparticles, 400 g/L of SiO₂ nanoparticles with a BET surface area of 300 m²/g and a diameter of the particles of 9 nm and 4-5 g/L of a non-ionic polyfluorinated surface active additive. To apply by spraying, it is possible to improve the mechanical properties of the dispersion by adding 20 g/L of an emulsifier, 40 g/L of a dispersing agent and possibly also 80 g/L of a hardener. Similarly, to improve antibacterial effects, 5-20 g of rutile (i.e., non-photocatalytic form of TiO₂) with regions of metallic Ag or insoluble Ag salt deposited on its surface, coating systems can be added into the system.

Depending on their porosity, the use of two types of composite systems is proposed for the surface treatment of solid materials (stone, concrete, ceramics, etc.). For low porous and low liquid-absorbing surfaces, typical composite systems contain 10 g/L of TiO₂ nanoparticles, 30 g/L of SiO₂ nanoparticles (typically with a mean particle diameter of 45 nm and BET surface area 100 m²/g) and 10 g/L of a non-ionic polyfluorinated surface active additive. Typically, 1 L of the composite system dispersion suffices for a surface treatment of ca. 20-36 m² of the surface. For highly porous and highly liquid-absorbing surfaces, more concentrated systems are more suitable. Typical composite systems contain 30 g/L of TiO₂ nanoparticles, 120 g/l of SiO₂ nanoparticles (typically with a mean particle diameter of 30 nm and a BET surface area of 300 m²/g) and 30 g/L of a non-ionic polyfluorinated surface active additive and, in addition, 1 g/L of an ionic polyfluorinated surface active additive, which facilitate the penetration of the spatial composite formations into the depth of the pores. Typically, 1 L of the composite system dispersion suits for a surface treatment of ca. 6-10 m² of the surface.

### EXAMPLE 1

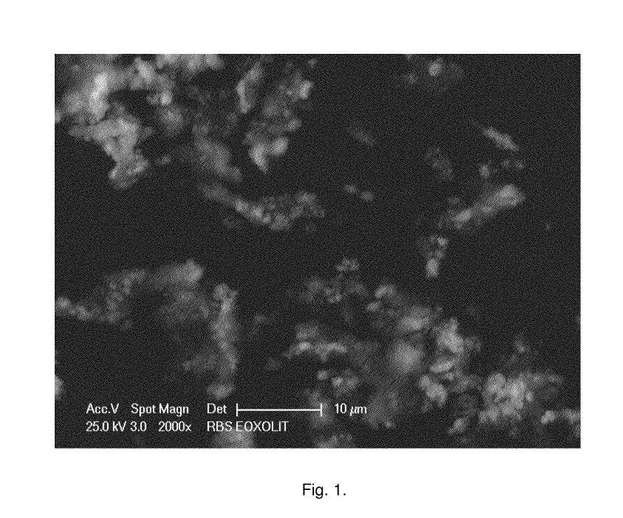

A photo-catalytic composition according to the invention comprising
10 g of TiO₂ powder of the type Vlp 7000 sold by Kronos and
40 g of a colloidal SiO₂ formulation, the SiO₂ having a BET surface of 300 m²/g, the formulation comprising 30 wt. % of active material
and 10 g of anionic PTFE
   was poured dropwise into liquid nitrogen, to freeze and preserve the physical structure of the composition. Then water was removed by sublimation at 7 mTorr and −60° C. The solid which remained after sublimation was studied by scanning electron microscopy (SEM) using a scanning electron microscope Philips XL 30 CP. The measurements were carried out at 25 kV using the RBS detector (BS electrons, enhancement of the material contrast) at pressure 0.5 mtorr. The SEM results are shown in FIG. 1.

At these conditions, TiO₂ forms lighter spots on the background of darker particles of SiO₂ particles in polytetrafluroethylene binder. From FIG. 1 it appears that SiO₂ particles are well dispersed in the photo catalytic composition, whereas TiO₂ forms discrete submicron aggregates which are separate from the SiO₂ particles.

The following examples show results for the photocatalytic effect obtained with the photocatalytic composition according to the invention.

The photocatalytic effect was measured according to the method described in JIS TR Z0018 (ISO22197-1) “Photocatalytic materials—Air purification test procedure”. A shortened version of the test is carried out. Each time, the test was carried out by measuring the NO concentration before irradiation, after irradiation with UV light and after irradiation with visible light. The light intensity of the UV light was in all experiments 10 W/m². The influence of the intensity of the visible light on the photocatalytic activity was evaluated by using as a light intensity for the visible light 20.000 lux, respectively 3.000 lux.

The experiment was carried out using a synthetic carpet sample of 20×10 cm from Desso type Levosit Red color, which had been treated with a photo-catalytic composition comprising
100 g of a TiO₂ type Vlp 7000 sold by Kronos
203.1 g of an aqueous anionic SiO₂ formulation, the SiO₂ having a BET surface of 300 m²/g and containing 30 wt. % of active material
An emulsifier, a dispersing and thickening agent and water were added till 1000 g.
   The thus obtained 10 wt. % TiO₂ formulation was diluted by adding 9 l of water to obtain a 1 wt. % TiO₂ formulation.

The results of the ability of the carpet to decompose organic components are summarized in table 1.

### EXAMPLE 3

The photocatalytic effect was tested of a photocatalytic composition which contained 100 g of TiO₂ of the type PK20A and an aqueous anionic colloidal SiO₂ with a BET surface of 300 m²/g. The SiO₂ formulation contained 30 wt. % of active material. The preparation of the photocatalytic composition was carried out according to example 2. The photocatalytic activity was tested on a synthetic Carpet sample of 20×10 cm from Desso type Levosit Red color. The results of the ability of the carpet to decompose organic components are summarized in table 1.

### EXAMPLE 4

The photocatalytic effect of the photocatalytic composition according to the invention was tested on a synthetic Carpet sample of 20×10 cm from Desso. The photocatalytic composition contained 50 g of TiO₂ of the type Vlp 7000 sold by Kronos and 130 g of an anionic aqueous colloidal SiO₂ formulation, the SiO₂ having a BET surface of 100/200 m²/g and containing 47 wt. % of SiO₂ with an average particle size of respectively 20 and 30 nm. The preparation was carried out as described in example 2. The results of the ability of the carpet to decompose organic components are summarized in table 1.

### EXAMPLE 5

The photocatalytic effect of the photocatalytic composition according to the invention was tested using a paint sample of Sigma Impulse base paint (PPG) applied on a 10×20 cm surface on a Ytong block surface. To the paint, the photo-catalytic composition according to the invention was added. The photo-catalytic composition comprised TiO₂ of the type Vlp 7000 sold by Kronos (example 5a) or PK20A H/L (example 5b), and an aqueous colloidal anionic SiO₂ formulation with a BET surface of 300 m²/g which contained 30 wt. % of active material. In example 5a, a 1 wt. % TiO₂ formulation was prepared using 10 g of the TiO₂ described above, and 40 g of SiO₂. The results of the ability of the carpet to decompose organic components are summarized in table 1. In example 5b, a 3 wt. % formulation was prepared using 30 g of TiO₂ and 120 g of the aqueous colloidal SiO₂ formulation described above.

The degradation results of example 5a are summarized in table 1:
UV-light: 1.035 ppm˜0.353 ppm
UV-light+Visible light (20000 lux): 0.353 ppm˜0.338 ppm
Visible light (±22000 lux): 1,021 ppm˜0.421 ppm
   The degradation results of example 5a are summarized in table 1:
The degradation results of example 5b are summarized in table 1:
UV-light: 1.077 ppm˜0.378 ppm
UV-light+Visible light (20000 lux): 0.378 ppm˜0.345 ppm
Visible light (20000 lux): 1.066 ppm˜0.758 ppm.

### EXAMPLE 6

Use was made of a STO paint sample of a neutral paint from STO, by applying a STO RAPID COLOR paint of size of 10×20 cm on a Ytong block surface. The paint contained the photo-catalytic composition according to the invention. The photo-catalytic composition comprised TiO₂ of the type Vlp 7000 sold by Kronos and anionic SiO₂ with a BET surface of 100/200 m²/g with 47 wt. % of active material. A formulation was prepared which contained 5 wt. % of TiO₂, using 50 g of TiO₂ of the type Vlp 7000 sold by Kronos and 130 g of SiO₂ with a BET surface of 300 m²/g with 30 wt. % of active material. The results of the ability of the paint to decompose organic components are summarized in table 1.

### EXAMPLE 7

### EXAMPLE 7a

Use was made of a Ytong stone surface of 9×19 cm, which had been treated with a non penetrating photo-catalytic composition comprising a 1 wt. % formulation (50 ml/m²) of TiO₂ of the type Vlp 7000 sold by Kronos and an anionic aqueous colloidal SiO₂ dispersion with a BET surface of 100 m²/g with 45 wt. % of active material and PTFE as a stabiliser. The formulation was prepared using 10 g of TiO₂ and 27.2 g of an aqueous colloidal SiO₂ dispersion, the SiO₂ having a BET surface of 100 m²/g and containing 45 wt. % of active material and 10 g PTFE Rudolf Ruco 1040. The results of the ability of the coating to decompose organic components are summarized in table 1.

### EXAMPLE 7b

A further experiment was carried out on a Ytong stone surface of 9×19 cm. The stone was treated with a non penetrating photo-catalytic composition comprising a 1wt. % formulation (50 ml/m²) of TiO₂ of the type P25 sold by Degussa and an anionic aqueous colloidal SiO₂ dispersion with a BET surface of 300 m²/g with 30 wt. % of active material and C6 EPF 2523. The formulation was prepared using 10 g of TiO₂ of the type P25 sold by Degussa and 40.5 g of SiO₂ with a BET surface of 300 m²/g with 30 wt. % of active material and 11.1 g C6 EPF 2523. The results of the ability of the coating to decompose organic components are summarized in table 1. The results were as follows:
Visible light (20000 lux): 1,014 ppm˜0,508 ppm
UV-light: 1,014 ppm˜0,322 ppm
UV-light+Visible light (20000 lux): 0,322 ppm˜0,313 ppm

### EXAMPLE 8

### EXAMPLE 8a

A concrete paver surface of 9×19 cm was coated with a penetrating photo-catalytic composition comprising
a 6 wt. % formulation (150 ml/m²) of TiO₂ of the type Vlp 7000 sold by Kronos
anionic SiO₂ with a BET surface of 300 m²/g with 30 wt. % of active is material,
C6 EPF 2523 and FSN.
   The formulation was prepared using 60 g of TiO₂ and 243 ml of SiO₂ and 66 g C6 EPF 2523 and 1 ml FSN (a flurorosurfactant).
The results of the ability of the coating to decompose organic components are summarized in table 1. The results were as follows:
UV-light: 1,043 ppm˜0,497 ppm
UV light+Visible light (20000 lux): 0,555 ppm˜0,472 ppm

### EXAMPLE 8b

A further experiment was carried out on a concrete paver surface of 9×19 cm. The stone was treated with a penetrating photo-catalytic composition comprising a 6 wt. % formulation (150 ml/m²) of TiO₂ of the type PK20A sold by Precheza and anionic SiO₂ with a BET surface of 300 m²/g with 30 wt. % of active material, C6 EPF 2523 and FSO (Dupont). The formulation was prepared using 60 g of TiO₂ and 66 g PTFE Rudolf Ruco 1040 and 0.4 ml FSO. The results of the ability of the coating to decompose organic components are summarized in table 1. The results were as follows:
Degradation results:
UV-light: 1,030 ppm˜0,284 ppm
UV-light+Visible light (20000 lux): 0,284 ppm˜0,229 ppm
Visible light (20000 lux): 0,229 ppm˜0,653 ppm

### EXAMPLE 8c

A further experiment was carried out on a concrete paver surface of 9×19 cm, which had been treated with a penetrating photo-catalytic composition comprising a 3 wt. % formulation (150 ml/m²) of TiO₂ of the type PK20A sold by Precheza and anionic SiO₂ with a BET surface of 300 m²/g with 30 wt. % of active material, C6 EPF 2523 (Rudolf Chemie) and FSO (Dupont). The formulation was prepared using 30 g of TiO₂ of the type PK20A and 121.5 ml of an aqueous colloidal SiO₂ dispersion, the SiO₂ having a BET surface of 300 m²/g with 30 wt. % of active material and 33 g PTFE Rudolf Ruco 1040 and 0.8 ml FSO. The results of the ability of the coating to decompose organic components are summarized in table 1.

TABLE 1

| | UV-light | UV-light | Visible light | |
|---|---|---|---|---|
| | Initial | NO concen- | Initial | NO concen- |
| | NO concen- | tration after | NO concen- | tration after |
| | tration | irradiation | tration | irradiation |
| Example | ppm | (ppm) | ppm | (ppm) |
| 2 | 0.998 | 0.809 | 0.809 | 0.619 |
| 3 | 1.039 | 0.808 | 1.035 | 0.998 |
| 4 | 1.000 | 0.700 | 1.000 | 0.950 |
| 5a | 1.035 | 0.353 | 0.353 | 0.338 |
| 5b | 1.077 | 0.378 | 0.378 | 0.345 |
| 6 | 1.000 | 0.350 | 1.000 | 0.630 |
| 7a | 0.982 | 0.298 | 0.982 | 0.300 |
| 7b | 1.014 | 0.508 | 1.014 | 0.322 |
| 8a | 1.043 | 0.497 | 0.555 | 0.472 |
| 8b | 1.030 | 0.284 | 0.284 | 0.229 |
| 8c | 1.002 | 0.623 | 1.012 | 0.920 |

1. A photo-catalytic composition, comprising nanoparticles of at least one photo-catalyst and an aqueous colloidal dispersion of SiO₂ nanoparticles, characterized in that the concentration of the photo-catalyst ranges from at least 20 to less than 50 parts by weight and the concentration of SiO₂provides the balance to 100 parts by weight.

2. The photo-catalytic composition according to claim 1, characterized in that the SiO₂.nanoparticles are anionic.

3. The photo-catalytic composition according to claim 1, characterized in that the SiO₂.nanoparticles are cationic.

4. The photo-catalytic composition according to claim 1, characterized in that the SiO₂.nanoparticles have a particle size between 5 and 50 nm, preferably between 5 and 40 nm.

5. The photo-catalytic composition according to claim 1, characterized in that the nanoparticles of the at least one photo-catalyst have a particle size between 5 and 3000 nm, preferably between 10 and 500 nm.

6. The photo-catalytic composition according to claim 1, characterized in that the photo-catalyst is anatase TiO₂.

7. The photo-catalytic composition according to claim 1, characterized in that the photo-catalytic composition comprises a buffer.

8. The photo-catalytic composition according to claim 7, characterized in that the buffer is at least one salt of a strong acid with a weak hydroxide or a weak acid with a strong hydroxide.

9. The photo-catalytic composition according to claim 1, characterized in that the pH of the photo-catalytic composition is in the range of (pH_{zpc}(SiO₂)+pH_{zpc}(photo-catalyst))/2+1 and (pH_{zpc}(SiO₂)+pH_{zpc}(photo-catalyst))/2−1.

10. The photo-catalytic composition according to claim 1, characterized in that the composition comprises at least one stabiliser.

11. The photo-catalytic composition according to claim 1, characterized in that the stabiliser comprises a cationic, an anionic or a non-ionic fluoropolymer.

12. The photo-catalytic composition according to claim 11, characterized in that the fluoropolymer is PTFE, which contains 6 to 8 carbon atoms.

13. The photo-catalytic composition according to claim 12, characterized in that the PTFE fluoropolymer is contained in a concentration of 0.1-20.0 wt. %, preferably 1.0-10.0 wt. %.

14. The photo-catalytic composition according to claim 1, characterized in that the stabiliser comprises at least one surfactant.

15. The photo-catalytic composition according to claim 14, characterized in that a non-ionic, cationic or anionic surfactant are contained in the photo-catalytic composition in a concentration which varies between 0.001-2.0 wt. %, preferably 0.005-1.0 wt. %.

16. The photo-catalytic composition according to claim 1, characterized in that the TiO₂ nanoparticles are contained in the composition as aggregates, with a mean particle size of at least 0.2 μm, preferably at least 1 μm.

17. The photo-catalytic composition according to claim 1, characterized in that the concentration of SiO₂ in the dispersion ranges from 0.6-48 wt. %, preferably 0.6-12 wt. %.

18. The photo-catalytic composition according to claim 1, characterized in that the concentration of TiO₂ in the dispersion ranges from 0.5-40 wt. %, preferably 0.5-10 wt. %.

19. A process for manufacturing the photo-catalytic composition according to claim 1, comprising adding nanoparticles of at least one photo-catalyst to an aqueous colloidal dispersion of SiO₂ nanoparticles with the concentration of the photo-catalyst ranging from at least 20 to less than 50 parts by weight and the concentration of SiO₂ providing the balance to 100 parts by weight.

20. The process for manufacturing the photo-catalytic composition according to claim 19, characterized in that the photocatalytic composition is mixed avoiding cavitation and without creating a vortex.

21. A photo-catalytic paint, varnish, tone support or cement additive comprising the photo-catalytic composition according to claim 2.

22. A photo-catalytic paint, varnish, tone support or cement additive comprising the photo-catalytic composition according to claim 2.

23. A photo-catalytic treating agent for stones, roofing and textile, comprising the photo-catalytic composition according to claim 1.
